(19) United States
(12) Patent Application Publication
(10) Pub. No.: US 2008/0303690 A1
(43) Pub. Date: Dec. 11, 2008

(54) Electronic device with remote finding function

(76) Inventor: En-Lin Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/892,684

(22) Filed: Aug. 27, 2007

(30) Foreign Application Priority Data
Jun. 7, 2007 (CN) 200720147090.2

(51) Int. Cl. G08B 5/22

(52) U.S. Cl. 340/825.49

(57) ABSTRACT

An electronic device with remote finding function includes a main body and a remote controller. The main body includes a first control circuit, a switch and a display unit. The first control circuit emits a wireless finding signal and receives a wireless responding signal via an antenna, wherein the antenna is directional; the switch is connected with the first control circuit to receive the user's input and actuate the wireless finding signal; the display unit is connected with the first control circuit to display the orientation of the wireless responding signal. Moreover, the remote controller has a second control circuit to receive the wireless finding signal, and then transmit the wireless responding signal thereby.

### BACKGROUND OF THE INVENTION

1. Field of the Invention

The present invention is an electronic device with remote finding function, and more particularly relates to the electronic device with remote finding function which indicates an orientation of a remote controller.

2. Description of the Prior Art

Due to the fact that technology is advancing day after day, the functions of an electronic device have various features. For example, many electronic devices have the function of remote control to enhance convenience by using infrared rays or radio waves. Therefore, the user may use a remote controller to operate the electronic devices with multiple functions in the remote control range.

As a result, the demands of the remote controller are significantly increasing. Once the remote controller is missed and cannot be found, it may be a troublesome question to the user. In view of the foregoing problems, the remote controller found easily for the user is the important issue to be solved.

### SUMMARY OF THE INVENTION

Other advantages of the present invention will become apparent from the following description taken in conjunction with the accompanying drawings wherein are set forth, by way of illustration and example, certain embodiments of the present invention.

In order to solve the above-mentioned problems, one object of the present invention is to provide an electronic device with remote finding function, which has a display unit to indicate the orientation from the remote controller to the electronic device, and so as to find the remote controller easily in the specific range.

To achieve the object mentioned above, one embodiment of the present invention is to provide an electronic device with remote finding function including a main body and a remote controller. The main body includes a first control circuit, a switch and a display unit. The first control circuit emits a wireless finding signal and receives a wireless responding signal via an antenna, wherein the antenna is directional. The switch electrically is connected with the first control circuit to receive the user's input, and actuate the wireless finding signal emitting from the first control circuit. The display unit electrically is connected with the first control circuit to display the transmitting direction of the wireless responding signal. A remote controller sets a second control circuit to receive the wireless finding signal and transmit the wireless responding signal thereby.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block diagram illustrating an electronic device with remote finding function in accordance with the one embodiment of the present invention.

FIG. 2 is a schematic diagram illustrating a television with remote finding function in accordance with the one embodiment of the present invention.

### DESCRIPTION OF THE PREFERRED EMBODIMENT

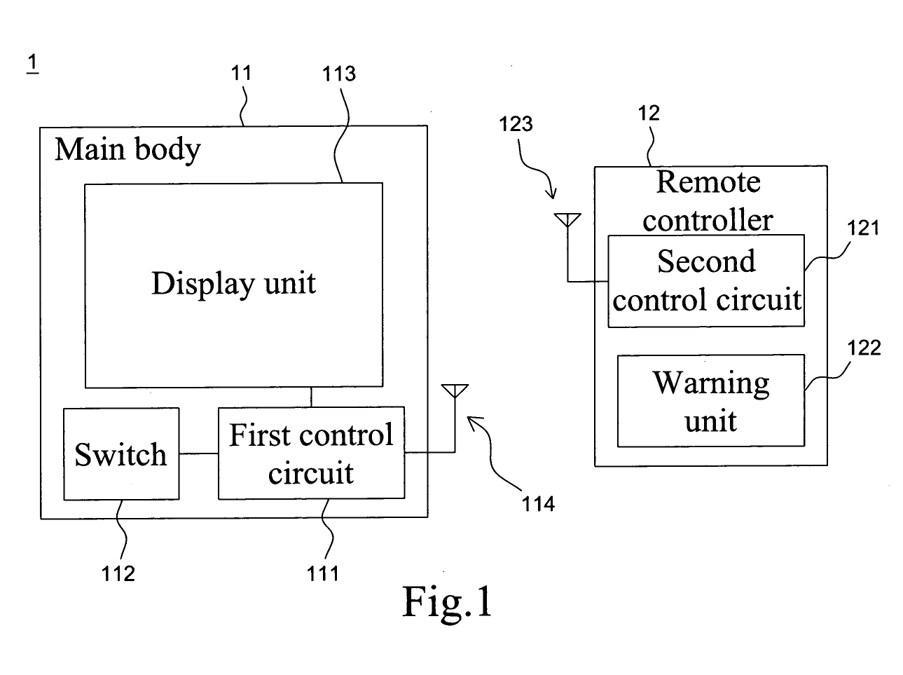

FIG. 1 is a block diagram illustrating an electronic device with remote finding function in accordance with the one embodiment of the present invention. As FIG. 1 shows, the electronic device 1 includes a main body 11 and a remote controller 12. The main body 11 can perform the functions of the electronic device 1. For example, the main body 11 may be a television, a multimedia-playing device or a projector. In another aspect, the remote controller 12 may enable the user to remotely control the main body 11. The relative prior arts will be apparent to those of ordinary skill in the art and not be described herein again.

Accordingly, the main body 11 includes a first control circuit 111, a switch 112 and a display unit 113. The first control circuit 111 emits a wireless finding signal and receives a wireless responding signal via an antenna 114, wherein the antenna 114 is directional. Therefore, the first control circuit 111 can identify the orientation of the wireless responding signal. The switch 112 is electrically connected with the first control circuit 111 to receive the user's input, and so as to actuate the first control circuit 111 to emit the wireless finding signal.

The display unit 113 is electrically connected with the first control circuit 111 to display the orientation of the wireless responding signal thereby. The remote controller 12 sets a second control circuit 121 to receive the wireless finding signal and transmit the wireless responding signal via an antenna 123.

In addition, the remote controller 12 has a warning unit 122. Once receiving the wireless finding signal, the second control circuit 121 emits a warning signal to notify the orientation of the remote controller 12. Preferably, the warning signal may be in the form of sound or light. In other words, the warning unit 122 may be a sonic element, such as a loudspeaker or a buzzer. Similarly, the warning unit 122 may be a light element, such as a LED or a lamp.

In one embodiment, an exemplary television explicates the process flow of an electronic device with remote finding function. Firstly, the user actuates the switch 112 of the main body 11, and then the first control circuit 111 emits the wireless finding signal. Thereafter, the second control circuit 121 of the remote controller 12 receives the wireless finding signal, and then transmits the wireless responding signal.

Next, the first control circuit 111 receives the wireless responding signal from the remote controller 12 via the antenna 114. Because the antenna 114 may be directional, the first control circuit 111 can identify the orientation of the wireless responding signal. Subsequently, the first control circuit 111 can display the orientation of the wireless responding signal by using the display unit 113 of the main body 11.

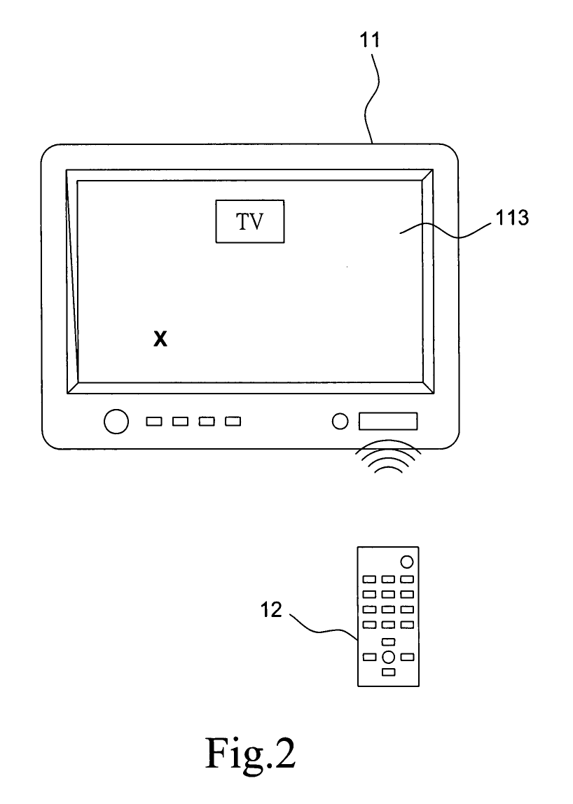

In one preferred embodiment, as FIG. 2 shows, the display unit 113 of the main body 11 may show the orientation from the remote controller to the television. The marks “X” and “TV” on the display unit 113 represent the remote controller and the television respectively. Preferably, please referring to the FIG. 1 again, the second control circuit 121 receives the wireless finding signal, and then actuates the warning unit 122 to emit the warning signal, either in the form of the sound or the light. Therefore, the user can search the orientation of the remote controller 12.

To sum up, the present invention has the electronic device with remote finding function, and may indicate the orientation from the remote controller to the electronic device to find the remote controller easily for the user in the specific range. Consequently, the user may find out the remote controller without any trouble. Moreover, the remote controller may set the warning unit to emit the warning signal by using the light or the sound, and so as to assist the user to find the remote controller easily.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An electronic device with remote finding function comprising:
a main body comprising:
a first control circuit emitting a wireless finding signal and receiving a wireless responding signal via an antenna, wherein the antenna is directional;
a switch electrically connected with the first control circuit to receive a user's input and actuate the first control circuit to emit the wireless responding signal; and
a display unit electrically connected with the first control circuit to display the orientation of the wireless responding signal thereon; and
a remote controller set a second control circuit to receive the wireless finding signal and transmit the wireless responding signal thereby.

2. The electronic device with remote finding function according to claim 1, wherein the remote controller further comprises a warming unit to emit the warming signal to notify the user, once the second control circuit receives the wireless finding signal.

3. The electronic device with remote finding function according to claim 1, wherein the warming unit is a sonic element.

4. The electronic device with remote finding function according to claim 3, wherein the sound element is a loudspeaker or a buzzer.

5. The electronic device with remote finding function according to claim 1, wherein the warming unit is a light element.

6. The electronic device with remote finding function according to claim 5, wherein the light element is a LED or a lamp.

7. The electronic device with remote finding function according to claim 1, wherein the electronic device is a television, a multimedia-playing device or a projector.
